(19) United States
(12) Patent Application Publication
(10) Pub. No.: US 2026/0087423 A1
(43) Pub. Date: Mar. 26, 2026

(54) COMPUTER-IMPLEMENTED NESTING METHOD FOR GENERATING A NESTING PLAN BY NESTING WORKPIECE PARTS ON A WORKPIECE SHEET

(71) Applicant: TRUMPF Werkzeugmaschinen SE + Co. KG, Ditzingen (DE)

(72) Inventor: Wolf Wadehn, Tamil Nadu (IN)

(21) Appl. No.: 19/404,055

(22) Filed: Dec. 1, 2025

Related U.S. Application Data
(63) Continuation of application No. PCT/EP2024/063363, filed on May 15, 2024.

(30) Foreign Application Priority Data
Jun. 5, 2023 (DE) 10 2023 114 648.3

(51) Int. Cl. G06Q 10/04; B23K 26/38

(52) U.S. Cl. CPC G06Q 10/043; B23K 26/38

(57) ABSTRACT

A nesting method for generating a nesting plan by nesting workpiece parts with different two-dimensional workpiece part geometries on a workpiece sheet with a two-dimensional workpiece sheet geometry, wherein the nesting plan is configured to be used for a laser cutting method for cutting the workpiece parts nested according to the nesting plan out of the workpiece sheet placed on a workpiece support. The nesting method includes reading in geometry data of the workpiece parts, ascertaining individual geometry characteristics of at least some of the workpiece parts from their geometry data, determining individual workpiece spacings between adjacent workpiece parts on the workpiece sheet based on their individual geometry characteristics, and nesting the workpiece parts with their individual workpiece spacings on the workpiece sheet.

### CROSS REFERENCE TO RELATED APPLICATIONS

This application is a continuation of International Application No. PCT/EP2024/063363 (published as WO 2024/251481 A1), filed on May 15, 2024, and claims benefit to German Patent Application No. DE 10 2023 114 648.3, filed on Jun. 5, 2023. The aforementioned applications are hereby incorporated by reference herein.

### FIELD

The invention relates to a computer-implemented nesting method for generating a nesting plan and to a laser cutting method for cutting the workpiece parts nested according to the nesting plan out of a workpiece sheet placed on a workpiece support.

### BACKGROUND

A cutting method in which workpiece parts are cut out of a workpiece sheet, and upstream nesting methods, for example using exact or heuristic methods, are known from the prior art. Nesting refers to the allocation or placement of the workpiece parts to be cut on the workpiece sheet for the subsequent laser-cutting method. In other words, the workpiece parts to be cut out with their workpiece part geometry are assigned unique positions on the workpiece sheet or the workpiece sheet geometry thereof. This assignment or allocation, which is referred to herein as nesting of the workpiece parts on the workpiece sheet, is stored in the nesting plan. The nesting plan can be called up in the laser cutting method and, by tracing the cutting edges with a laser according to the contours of the workpiece parts on the workpiece sheet, the workpiece sheet can be cut to obtain the individual workpiece parts.

The purpose of the nesting method is to create a nesting plan that allows the workpiece sheet to be used as efficiently as possible, such that as little waste as possible is generated.

One challenge with the nesting method is that during laser cutting, a lot of laser energy is radiated in the direction of the workpiece support with the workpiece sheet resting thereon, since only a part of the laser energy is absorbed by the material of the workpiece sheet to be cut. The workpiece support is therefore typically considered a wearing part that needs to be replaced frequently. Such a workpiece support typically consists of vertical support bars that support the parts on evenly distributed tips. A problem with such workpiece supports is that the cut-out workpiece parts can tend to tilt, which creates a risk of collision between the tilted workpiece part and the laser cutting head used for the laser cutting method.

One way to minimize this risk is to use a uniform minimum workpiece part distance between any two adjacent workpiece parts in the nesting plan, which can be selected in particular depending on the radius of the laser cutting head or its nozzle, so that a currently cut and tilted workpiece part can be passed without collision occurring when the next workpiece part is cut. In the prior art, a uniform and conservative spacing between workpiece parts, for example 15 mm, is chosen across all workpiece parts.

### SUMMARY

In an embodiment, the present disclosure provides a nesting method for generating a nesting plan by nesting workpiece parts with different two-dimensional workpiece part geometries on a workpiece sheet with a two-dimensional workpiece sheet geometry, wherein the nesting plan is configured to be used for a laser cutting method for cutting the workpiece parts nested according to the nesting plan out of the workpiece sheet placed on a workpiece support.

The nesting method comprises reading in geometry data of the workpiece parts, ascertaining individual geometry characteristics of at least some of the workpiece parts from their geometry data, determining individual workpiece spacings between adjacent workpiece parts on the workpiece sheet based on their individual geometry characteristics, and nesting the workpiece parts with their individual workpiece spacings on the workpiece sheet.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a perspective view of a system in a form of a machine tool according to an exemplary embodiment of the present disclosure;

FIG. 2 illustrates a schematic view of a laser-cutting device as part of the machine tool of FIG. 1;

FIG. 3 illustrates a schematic view of a nesting plan;

FIG. 4 illustrates a schematic view of a nesting method according to an exemplary embodiment of the present disclosure; and

FIG. 5 illustrates a schematic view of the nesting method of FIG. 4 in application.

### DETAILED DESCRIPTION

According to the present disclosure, it has been found that a uniform workpiece spacing leads to a high degree of inefficiency in terms of material use. As such, a conservative workpiece spacing is not always necessary.

In an embodiment, the present disclosure provides a nesting method with which particularly efficient nesting plans can be generated.

The foregoing is achieved using a computer-implemented nesting method according to an embodiment of the present disclosure. Accordingly, a computer-implemented nesting method is provided for generating a nesting plan by nesting workpiece parts with, in particular, different, two-dimensional workpiece part geometries on a workpiece sheet with a two-dimensional workpiece sheet geometry, wherein the nesting plan can be used for a laser cutting method for cutting the workpiece parts nested according to the nesting plan out of the workpiece sheet placed on a workpiece support, in particular on a support grid, and wherein the nesting method comprises the following method steps:
(a) reading in geometry data of the workpiece parts,
(b) ascertaining individual geometry characteristics of at least some of the workpiece parts from their geometry data,
(c) determining individual workpiece spacings between adjacent workpiece parts on the workpiece sheet based on their individual geometry characteristics, and
(d) nesting the workpiece parts with their individual workpiece spacings on the workpiece sheet.

The nesting method according to the present disclosure enables a significantly more efficient use of the workpiece sheet by nesting with individual workpiece spacings instead of a conservative, uniform workpiece spacing. Due to the individual workpiece spacings, smaller workpiece spacings can also be selected between at least some or all of the workpiece parts, so that space or surface area is saved on the workpiece sheet, which in turn can be used to arrange or nest additional workpiece parts thereon. In this way, the material of the workpiece sheet is reduced from the residual skeleton remaining after cutting, or there is less waste. Such increased material efficiency through closer nesting of the workpiece parts can be achieved according to the present disclosure, as described in more detail below, while maintaining a high level of process reliability with regard to the laser cutting method.

The individual workpiece spacings are not chosen randomly. Instead, the individual workpiece spacings are determined based on geometry data that is previously read-in. For this purpose, individual geometry characteristics of some or all workpiece parts that are nested on the workpiece sheet are ascertained from the read-in geometry data. This makes it possible to use the geometries of the individual workpiece parts as a basis for determining the workpiece spacings and thus to select individual workpiece spacings depending on the geometry. Individual means in particular that a workpiece spacing is selected individually for each workpiece part. This does not mean that all workpiece spacings from adjacent workpiece parts must be different.

The individual workpiece spacings can be freely selected or come from a group of at least two or more defined workpiece spacings in order to speed up the nesting method. The individual workpiece spacings can be determined, for example, using an algorithm, artificial intelligence, a look-up table, etc. In particular, when determining an individual workpiece spacing of a workpiece part, its own geometry characteristics and the geometry characteristics of at least one workpiece part or all (immediately) adjacent workpiece parts are taken into account.

The nesting method can generate a nesting plan for the first time or be applied to an already generated nesting plan so that it is partially re-nested (in method step (d)). In principle, the nesting problem of efficiently nesting workpiece parts on a workpiece sheet can be divided into three sub-problems. Firstly, it can be determined which workpiece part should be placed or nested on which workpiece sheet. Secondly, the order in which the individual workpiece parts should be nested can be determined. Thirdly, the unique position of each workpiece part on the workpiece sheet can be determined. Each subproblem can be solved using different methods, in particular precise methods, heuristic methods, the use of artificial intelligence, etc. The nesting method according to the present disclosure can, if required, implement various of the known methods for efficient nesting. However, in this case, it is only necessary with regard to nesting that the individual workpiece spacings are used for nesting the workpiece parts. In other words, the nesting method according to the present disclosure can of course implement further methods which, in addition to the individual workpiece spacings, specify the position, orientation, etc. of the individual workpiece parts on the workpiece sheet in order to enable efficient nesting.

The fact that method step (b) is carried out for at least some of the workpiece parts to be nested means that the workpiece spacing for at least one or more workpiece parts can be determined using a different method, for example by means of a rigidly defined workpiece spacing. Nevertheless, it can of course be provided that individual workpiece spacings are determined for all of the workpiece parts to be nested on the workpiece sheet in order to carry out the nesting. Furthermore, the method steps (a) to (d) are carried out in the order specified.

In particular, it can be provided that the individual geometry characteristics are ascertained by comparing the read-in geometry data with at least one predetermined geometry parameter. The advantage of this is that the geometry data is evaluated in a defined way in order to obtain the individual geometry characteristics.

In particular, it can be provided that the at least one geometry parameter is predetermined such that it is indicative of a process risk of the laser cutting method. By comparing one or more geometry parameters with the geometry data, which geometry parameters correlate with or are indicative of at least one of the process risk parameters listed below, individual workpiece spacings can be determined in a way that is optimized with regard to material efficiency on the one hand and process reliability on the other.

It can be provided that the process risk is a process stability of the laser cutting method, a probability of the workpiece parts tilting on the workpiece support, a probability of the workpiece parts colliding with a cutting head used in the laser cutting method and/or a probability of the workpiece parts falling through the workpiece support, in particular the support grid. For example, the higher the probability of a workpiece part tilting based on its geometry parameter(s), the larger its individual workpiece spacing can be selected. Conversely, if the probability of tilting is low, and especially if the other process risk parameters are also favorable, a small individual workpiece spacing can be determined. This ensures that large workpiece spacings are only used on the workpiece sheet or in the nesting plan where there is a process risk, in particular of a type defined by the above process risk parameters. However, where the process risk is low, the workpiece spacing can be kept to a minimum or even eliminated completely. However, a certain minimum workpiece spacing is typically desired for high cutting quality, so that a minimum workpiece spacing is preferably maintained in the nesting plan, even if individual workpiece spacings are determined. This minimum workpiece spacing is of course smaller than the previously mentioned conservative uniform workpiece spacing from the prior art, which is selected to minimize the process risk.

In particular, the individual geometry characteristics can each provide a value for at least one of the aforementioned process risk parameters of process stability, probability of tilting, probability of collision and probability of falling. By means of such a calculation, the process risk emanating from a workpiece part can be specified by specifying the individual geometry characteristics.

In particular, it can be provided that the at least one geometry parameter is at least one of the following geometry parameters: a support surface, a center of gravity and an extension along at least one coordinate in a two-dimensional coordinate system. It has been demonstrated to a particularly high degree that the aforementioned geometry parameters have a decisive influence on relevant process risk parameters in the laser cutting method, especially on the aforementioned process parameters of process stability, probability of tilting, probability of collision, and probability of falling. For example, it can be crucial whether the support surface of a workpiece part typically rests on more or fewer than three support pins of the workpiece support. It can also be decisive whether a workpiece part typically rests on two support pins of the workpiece support along the two coordinates or axes of the two-dimensional coordinate system. These factors and, for example, the center of gravity of the workpiece part, as geometry parameters, determine the process risk for a workpiece part, in particular its probability of tilting and collision. By comparing the geometry data with these geometry parameters, the level of process risk can be estimated. Different value ranges for the geometry parameters can be stored, for example in the previously mentioned look-up table, especially with different process risk values and, if necessary, also with workpiece spacings for the respective value ranges or process risk values. This means individual workpiece spacings can be determined for each workpiece part particularly quickly.

Furthermore, it can be provided that the workpiece support comprises support areas which are formed in particular by support webs and/or support pins. In one variant, the support pins can be arranged on the support webs, whereby the support webs are arranged parallel to each other. A workpiece support having such support areas has the advantage that it can be manufactured cost-effectively and enables simple laser machining of a workpiece sheet resting thereon. However, it has the disadvantage that it can be damaged by the laser, meaning it must be repaired or replaced, and that workpiece parts thereon can tilt and collide with the cutting head.

In principle, the nesting method according to the present disclosure can be carried out independently of the knowledge of the position of the individual workpiece parts on the workpiece support, in particular the support webs and/or support pins. However, it has been demonstrated that the structure of the workpiece support and the arrangement of the workpiece parts on the workpiece support, in particular their support pins, also play a role in the process risk explained above, in particular whether there is any tilting of workpiece parts and if a collision with the cutting head is possible. In particular, in order to reduce the process risk, an expected position of the workpiece parts on the workpiece support can be determined when determining the individual workpiece spacings and to take this expected position into account when determining the individual workpiece spacings.

In particular, the expected position can comprise information about which support areas, for example support pins, of the workpiece support the workpiece parts rest on and this information is taken into account when determining the individual workpiece spacings. The expected position can be ascertained, for example, by appropriate sensors and/or cameras on the corresponding machine tool.

Furthermore, it can be provided that at least one cutting parameter of the laser cutting method, a machine parameter of a machine tool for machining the workpiece sheet and/or a material parameter of the workpiece sheet is taken into account when determining the individual workpiece spacings. The cutting parameter can in particular be a gas pressure and/or a cutting gap width. The material parameter can be, for example, a material thickness and/or a material weight, in particular a specific weight per volume. In this way, the individual workpiece spacings can be determined even more precisely so that a specific, particularly pre-selected, process risk is not exceeded.

In principle, a process risk of the laser cutting method can be predetermined in a separate method step and taken into account when determining the individual workpiece spacings. In this way, a measure of material efficiency and process reliability of the nesting method, which are at least partially opposing objectives of the nesting method, can be predetermined in each case by the corresponding determination of the individual workpiece spacings.

Furthermore, it can be provided that the workpiece parts are classified into at least two geometry classes based on their geometry data and that individual geometry characteristics are ascertained only for those workpiece parts that fall into a predefined one of the two geometry classes. One of the at least two geometry classes can be selected in such a way that workpiece parts that have a (minimum) process risk are classified in this geometry class. This allows a preselection of workpiece parts based on their process risk. If, for example, workpiece parts are typically very stable on the workpiece support based on their geometry data, for example because they are very large and rest on many support points of the workpiece support, the process risk of these workpiece parts tilting and colliding with the cutting head is very low. By classifying such workpiece parts into a geometry class without process risk, it is no longer necessary to carry out the nesting method with all method steps for these workpiece parts. Instead, for example, a predefined minimum workpiece spacing can be selected for each of these workpiece parts, which can be a minimum value for a desired cutting quality. For example, workpiece parts that are very small and would therefore fall through the workpiece support and therefore cannot collide with the cutting head can be classified into a further geometry class. Such workpiece parts are typically nested in such a way that they remain on the residual skeleton after laser cutting with microjoints. For these workpiece parts, it is also not necessary to carry out the entire nesting method with steps (a) to (d). This allows the nesting method to concentrate on the critical workpiece parts through intelligent preselection. This is because the individual geometry characteristics are only ascertained for those workpiece parts that fall into the predefined geometry class for which a process risk exists.

Furthermore, it can be provided that the nesting method further comprises the method step of determining individual workpiece orientations on the workpiece sheet for at least some of the workpiece parts based on their individual geometry characteristics. By determining the individual workpiece orientation, it can now be determined whether the process risk of a workpiece part can be reduced by reorientation, especially if the relative position of the workpiece part on the support areas of the workpiece support is known. Based on the individual geometry characteristics, the process risk of a workpiece part can now be determined and, if necessary, reduced by reorientation on the workpiece sheet.

The above-mentioned advantages are further achieved by a computer program product according to an embodiment of the present disclosure. The computer program product comprises commands which, when the program is executed by a computer, cause the latter to carry out the nesting method according to the present disclosure.

The computer program product can, for example, be a computer program code per se or a product that contains the computer program, for example a data carrier or a data storage device.

The above-mentioned advantages are also achieved by a machining method according to an embodiment of the present disclosure. The machining method is designed for machining a workpiece sheet, wherein the machining method comprises:
the nesting method according to the present disclosure for generating a nesting plan for nesting workpiece parts with different two-dimensional workpiece part geometries on a workpiece sheet with a two-dimensional workpiece sheet geometry, and
a laser cutting method for cutting the workpiece parts nested according to the nesting plan out of the workpiece sheet, in particular by means of a laser-cutting beam emerging from a cutting head, wherein, in order to cut out the workpiece parts, the laser-cutting beam is used to trace cutting contours of the workpiece part geometries of the workpiece parts nested according to the nesting plan on the workpiece sheet.

The above-mentioned advantages are finally also achieved by a system according to an embodiment of the present disclosure. The system is configured for machining a workpiece sheet, wherein the system comprises:
a computer for carrying out the nesting method of the machining method according to the present disclosure, and
a laser-cutting device for carrying out the laser-cutting method of the machining method (according to the present disclosure).

The computer, which can be embodied in particular as the control unit or as part of a control unit, can also be used to control the cutting device. The computer can include the computer program product according to the present disclosure.

The computer and the laser-cutting device can be spatially distanced from one another or close to one another. For example, they can be connected to one another via wireless communication or wired communication, or at least be configured for such a communication link. For example, the computer can be on a remote cloud and wirelessly transmit the generated nesting plan to the laser-cutting device, in particular a machine tool with the laser-cutting device. Alternatively, the machine tool can generate the nesting plan locally using the computer.

The system can in particular include a machine tool, wherein the laser-cutting device can be part of the machine tool. It goes without saying that such a machine tool can also have further components that are necessary or beneficial for the machining method, such as a workpiece support, a workpiece part collecting device, a (linear) robot for moving the cutting head, etc. If the computer is located in the machine tool, the system can in particular be formed by the machine tool.

Features described herein with respect to the nesting method apply equally to the computer program product, the machining method and the system, and vice versa.

Further details and advantageous configurations of the present disclosure can be found in the following description, on the basis of which exemplary embodiments of the present disclosure are described and explained in greater detail.

In the following description and the figures, the same reference signs are used in each case for identical or mutually corresponding features.

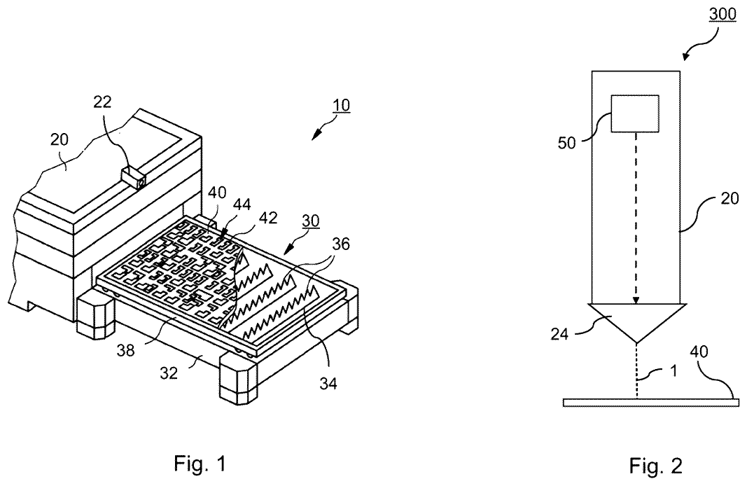

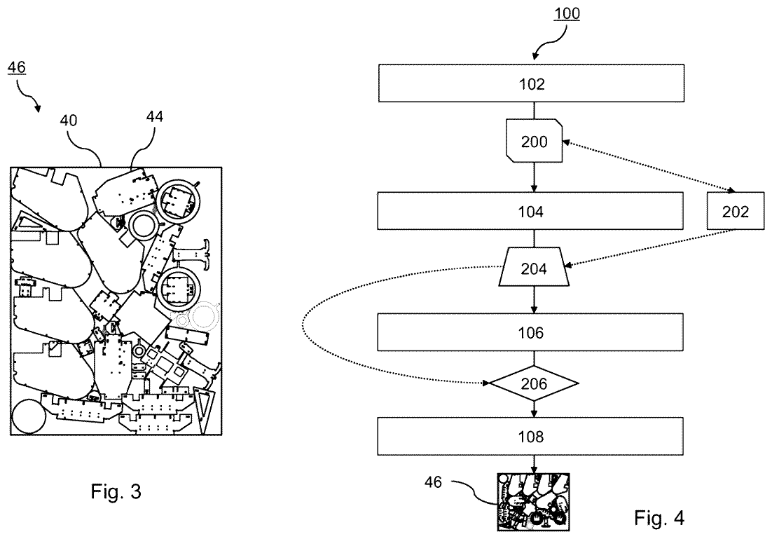

FIG. 1 shows a system 10 in the form of a machine tool, more particularly in the form of a laser-cutting machine, more particularly in the form of a laser-cutting flatbed machine tool, with a laser-cutting device 20, in which a laser-cutting method is carried out with a laser-cutting beam 1 (see FIG. 2). In particular, the focus of the laser-cutting beam 1 is guided by a computer 50 (see FIG. 2), in particular in the form of a control device of the machine tool, along predetermined cutting contours 42 arranged in a cutting region over a plate-shaped workpiece sheet 40, in particular a metal sheet extending substantially two-dimensionally, in order to cut out therefrom workpiece parts 44 with specific shapes or geometries predetermined according to a nesting plan 46 (see FIG. 3) (see predetermined shapes of the workpiece parts 44 in the workpiece sheet 40 according to the nesting plan 46). The nesting plan 46 can be predetermined by a control plan for the computer 50.

The machine tool here further comprises, by way of example, a removal device 30. The removal device 30 is here shown open for the sake of better illustration, but can alternatively also be partially or completely enclosed like the laser-cutting device 20 in FIG. 1. The removal device 30 comprises, for example, a pallet changer 32. The pallet changer 32 is configured to position one or more pallets 38 during manufacture. A workpiece sheet 40 to be cut can be placed and stored (as raw or starting material) on a pallet 38 and introduced into the housing of the laser-cutting device 20 for the laser-cutting method. Once the cutting process is complete, the pallet 38 with the machined workpiece sheet 40 can be moved out of the laser-cutting device 20, as shown in FIG. 1, such that workpiece parts 44 cut according to the nesting plan 46 can be separated from the residual workpiece remaining from the workpiece sheet 40 and removed from the machine tool.

FIG. 2 shows a laser-cutting method 300 in the laser-cutting device 20. A cutting head 24, which is controlled by the computer 50 and emits onto the workpiece sheet 40 the laser-cutting beam 1 for cutting out the workpiece parts 44 from the workpiece sheet 40, can be freely positioned in the cutting region such that the laser-cutting beam 1 can be guided substantially along any desired two-dimensional cutting contours 42 over the workpiece sheet 40 to be cut. In this case, a cutting contour 42 for the laser-cutting beam 1 is predetermined in the computer 50 in each case on the basis of the nesting plan 46 in order to cut out the workpiece parts 44 from the workpiece sheet 40. The computer 50 is shown here by way of example as a fixed part of the machine tool, but can alternatively be wirelessly connected to the machine tool and thus form the system 10. A computer 50 other than the computer 50 shown can also be used for nesting. The nesting plan 46 indicates the arrangement of the individual workpiece parts 44 on the workpiece sheet 40, as shown in FIG. 1. In addition, the nesting plan 46 can comprise predetermining piercing points and predetermined first cuts for inserting the laser-cutting beam 1 and guiding said laser-cutting beam 1 along the first cuts to the cutting contour 42.

During laser-cutting, the laser-cutting beam 1 heats the metal of the workpiece sheet 40 along the predetermined cutting contours 42 until it melts. A cutting gas jet, in particular of nitrogen or oxygen, can exit the cutting head 24 in the region of the laser-cutting beam 1 and push the molten material of the workpiece sheet 40 downwards and out of the gap that is formed. The workpiece sheet 40 is thus completely severed by the laser-cutting beam 1 during cutting.

To cut out a workpiece part 44, the laser-cutting beam 1 is moved along the predetermined cutting contours 42 of the respective workpiece sheet 40. This begins at one of the previously mentioned piercing points, which lie outside the workpiece parts 44, and then approaches the contour of the respective workpiece part 44, in particular in an arcuate first cut.

In the exemplary embodiment shown, the pallet 38 has a workpiece support 36. The workpiece support 36 has a plurality of support bars 34 which run transversely of, in particular perpendicularly to, the direction of insertion of the workpiece 40 into the laser-cutting device 20 and are aligned parallel to one another. The support bars 34 form support areas on which the workpiece sheet 40 is laid or placed.

FIG. 1 further shows a camera 22 of the machine tool, which is arranged, by way of example, on the laser-cutting device 20 or the housing thereof. The camera 22 can be part of the computer 50 of the machine tool or can be connected thereto. The camera 22 is here directed, purely by way of example and for the sake of better illustration, at the removal device 30 and can alternatively or additionally also be directed at the laser-cutting device 20, in particular arranged within the housing of the laser-cutting device 20. In addition, sensors can also be used alternatively or in addition to the camera 22.

FIG. 4 shows a computer-implemented nesting method 100 for generating the nesting plan 46. A corresponding nesting system can be partially or completely included in a computer program product. The nesting system and the nesting method 100 can be carried out, for example, by the computer 50 or another control device or a computer of the machine tool.

As shown in FIG. 4, the nesting method 100 includes various method steps 102, 104, 106, 108. In a first method step 102, geometry data 200 of the workpiece parts 44 to be nested on the workpiece sheet 40 is read-in. This geometry data can be present, for example, in the form of CAD data.

In a second method step 104, individual geometry characteristics 204 of the workpiece parts 44 are ascertained from the geometry data 200. For this purpose, the read-in geometry data 200 is compared with one or more predetermined geometry parameters 202, which are indicative of a process risk in the laser cutting method 300. This process risk is in particular a probability of the workpiece parts 44 tilting and/or a probability of the workpiece parts 44 colliding with the cutting head 24, in particular if they tip over on the workpiece support 36.

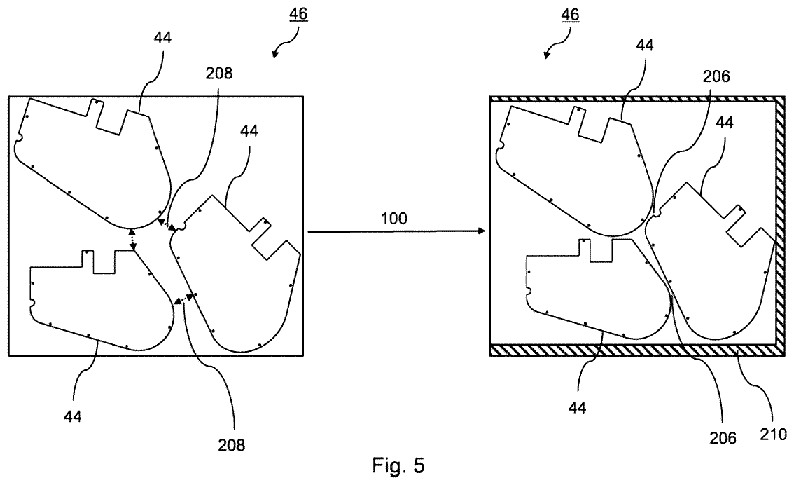

In a third method step 106 of the nesting method 100, individual workpiece spacings 206 between adjacent workpiece parts 44 on the workpiece sheet 40 are then determined based on the previously ascertained individual workpiece characteristics 204. Contrary to what is known, no uniform workpiece spacing 208 (see FIG. 5) is used to minimize the process risk, as in the prior art.

Finally, in a fourth method step 108 of the nesting method 100, the workpiece parts 44 are nested with their previously determined individual workpiece spacings 206 on the workpiece sheet 40. This can be an initial nesting process in which various algorithms, artificial intelligence or other methods can be used to implement the nesting as efficiently as possible. Alternatively, this can also be a re-nesting, in which an already existing nesting plan 46 is changed. Because the individual workpiece spacings 206 are smaller than conservative, uniform workpiece spacings 208 (see FIG. 5), as in the prior art, this results in a surface area gain 210 (see FIG. 5) on the workpiece sheet 40, so that additional workpiece parts 44 can also be nested on the workpiece sheet 40.

An illustrative example of the implementation of the nesting method 100 of FIG. 4 is shown schematically in FIG. 5 for a small and purely exemplary section of a nesting plan 46 with three nested workpiece parts 44. The nesting method 100 does not select the otherwise conservative and uniform workpiece spacings 208 between the workpiece parts 44. Instead, individual workpiece spacings 206 are selected, which take into account the process risk considered according to the geometry parameters 202. In the present case, in the right-hand section of the nesting plan 46, which is a result of the nesting method 100, it can be seen by way of example that the individual workpiece spacings 206 are each smaller than the uniform workpiece spacings 208 in the left-hand section of the nesting plan 46. When applied to all workpiece parts 44 and when considering the nesting plan 46 as a whole, it becomes clear that the previously mentioned surface area gain 210 (which is indicated here only schematically and by way of example as a dashed area) is achieved and that a more efficient nesting with less excess material can be achieved.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A nesting method for generating a nesting plan by nesting workpiece parts with different two-dimensional workpiece part geometries on a workpiece sheet with a two-dimensional workpiece sheet geometry, wherein the nesting plan is configured to be used for a laser cutting method for cutting the workpiece parts nested according to the nesting plan out of the workpiece sheet placed on a workpiece support, the nesting method comprising:
reading in geometry data of the workpiece parts;
ascertaining individual geometry characteristics of at least some of the workpiece parts from their geometry data;
determining individual workpiece spacings between adjacent workpiece parts on the workpiece sheet based on their individual geometry characteristics; and
nesting the workpiece parts with their individual workpiece spacings on the workpiece sheet.

2. The nesting method according to claim 1, wherein the individual geometry characteristics are ascertained by comparing the read-in geometry data with at least one predetermined geometry parameter.

3. The nesting method according to claim 2, wherein the at least one geometry parameter is predetermined such that it is indicative of a process risk of the laser cutting method.

4. The nesting method according to claim 3, wherein the process risk is a process stability of the laser cutting method, a probability of the workpiece parts tilting on the workpiece support, a probability of the workpiece parts colliding with a cutting head used in the laser cutting method and/or a probability of the workpiece parts falling through the workpiece support.

5. The nesting method according to claim 2, wherein the at least one geometry parameter is at least one of the following geometry parameters: a support surface, a center of gravity, and/or an extension along at least one coordinate in a two-dimensional coordinate system.

6. The nesting method according to claim 1, wherein the workpiece support comprises support areas which are formed by support webs and/or support pins.

7. The nesting method according to claim 1, wherein determining the individual workpiece spacings includes determining an expected position of the workpiece parts on the workpiece support and wherein the expected position is taken into account when determining the individual workpiece spacings.

8. The nesting method according to claim 7, wherein the expected position comprises information about which support areas of the workpiece support the workpiece parts are located on and wherein the information about which support areas of the workpiece support the workpiece parts are located on is used to determine the individual workpiece spacings.

9. The nesting method according to claim 1, wherein at least one cutting parameter of the laser cutting method, a machine parameter of a machine tool for machining the workpiece sheet and/or a material parameter of the workpiece sheet is used to determine the individual workpiece spacings.

10. The nesting method according to claim 9, wherein the cutting parameter is a gas pressure and/or a cutting gap width.

11. The nesting method according to claim 1, wherein the workpiece parts are classified into at least two geometry classes based on their geometry data and wherein individual geometry characteristics are ascertained only for workpiece parts which fall into a predefined one of the two geometry classes.

12. The nesting method according to claim 1, wherein the nesting method further comprises the method step of determining individual workpiece orientations on the workpiece sheet for at least some of the workpiece parts based on their individual geometry characteristics.

13. A non-transitory computer-readable medium having processor-executable instructions stored thereon, wherein the processor-executable instructions, when executed by one or more processors, facilitate performance of the method of claim 1.

14. A machining method for machining a workpiece sheet, wherein the machining method includes:
carrying out the nesting method according to claim 1; and
carrying out a cutting method for cutting the workpiece parts nested according to the nesting plan out of the workpiece sheet by a laser-cutting beam emerging from a cutting head, wherein, in order to cut out the workpiece parts, the laser-cutting beam is used to trace cutting contours of the workpiece part geometries of the workpiece parts nested according to the nesting plan on the workpiece sheet.

15. A system for machining a workpiece sheet according to the machining method of claim 14, wherein the system includes:
a computer configured to carry out the nesting method ; and
a laser-cutting device configured to carry out the cutting method.
